(19) United States
(12) Patent Application Publication
(10) Pub. No.: US 2014/0093637 A1
(43) Pub. Date: Apr. 3, 2014

(54) READY TO EAT COLD NUT CAKES WITH INGREDIENTS

(71) Applicant: Alice Chang, South Pasadena, CA (US)

(72) Inventor: Alice Chang, South Pasadena, CA (US)

(21) Appl. No.: 13/928,385

(22) Filed: Jun. 27, 2013

Related U.S. Application Data
(60) Provisional application No. 61/709,166, filed on Oct. 3, 2012.

(51) Int. Cl. A23L 1/36

(52) U.S. Cl. CPC A23L 1/366
USPC 426/632

(57) ABSTRACT

Cold and ready to eat nut cakes, with a variety of ingredient combinations suitable for healthy consumption. Serving size can be a single serving, or a six pack of servings for convenience such that the inherent nutritional aspects of nuts are able to be included in consumer's diets.

### CROSS-REFERENCE TO RELATED APPLICATION

The present application is related to and claims priority from prior provisional application Ser. No. 61/709,166, filed Oct. 3, 2012 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of comestibles and more specifically relates to ready to eat cold nut cakes.

2. Description of the Related Art

A nut is a hard-shelled indehiscent fruit of some plants. While a wide variety of dried seeds and fruits are referred to generally as nuts, only a certain number of them are considered by biologists to be true nuts. Nuts are an important source of nutrients for both humans and wildlife. Nuts are a composite of the seed and the fruit, where the fruit does not open to release the seed. Most seeds come from fruits, and the seeds are free of the fruit, unlike nuts such as hazelnuts, hickories, chestnuts and acorns, which have a stony fruit wall and originate from a compound ovary. Everyday common usage of the term often refers to any hard-walled, edible kernel as a nut. A nut in cuisine is a much less restrictive category than a nut in botany, as the term is applied to many seeds that are not botanically true nuts. Any large, oily kernel found within a shell and used in food may be regarded as a nut.

Nuts generally have a high oil content; they are a highly prized food and energy source. A large number of seeds are edible by humans and used in cooking, eaten raw, sprouted, or roasted as a snack food, or pressed for oil that is used in cookery. However, it may be difficult to prepare and use nuts in foods on a regular basis to nutritionally benefit the consumer. A more efficient option is needed to provide people who shop for nuts (for food) the option of getting processed nut cakes, which have a soft and smooth texture for user consumption; with the nut cakes providing valuable nutrition.

Various attempts have been made to solve the above-mentioned problems such as those found in U.S. Pat. and Pub. Nos. 2011/0097452; U.S. Pat. Nos. 6,352,738; 8,216,623; 5,498,438; 2002/0051837; U.S. Pat. No. 4,800,097; and 2009/0004356. This art is representative of comestibles relating to nuts. None of the above inventions and patents, taken either singly or in combination, is seen to describe the invention as claimed.

Ideally, ready to eat cold nut cakes should provide nutrition and convenience to consumers and, yet would be manufactured at a modest expense. Thus, a need exists for ready to eat cold nut cakes to avoid the above-mentioned problems.

### BRIEF SUMMARY OF THE INVENTION

In view of the foregoing disadvantages inherent in the known nut-related comestibles art, the present invention provides novel ready to eat cold nut cakes. The general purpose of the present invention, which will be described subsequently in greater detail is to provide cold and ready to eat nut cakes, and with a variety of ingredients. The invention is to provide people who shop for nuts the option of getting processed nut cakes, which have a soft and smooth texture.

A ready to eat cold nut cake product comprising ingredients is disclosed herein combined in proportions substantially including: nuts; milk; a gelling agent; additives; and flavorings. The nuts are ground into very fine particles to form fine flour. The (nut) flour, milk, gelling agent, additives and flavorings are stirred, mixed as an admixture and cooked to form nut cakes as a ready to eat cold nut cake product. The gelling agent causes the admixture to congeal (after being cooked) when the admixture is cooled using refrigeration. The flavorings cause the nut cakes to be flavored (as per consumer preference) for consumption; the nut cakes are high in nutrition and suitable for readily consuming. Various flavored versions of the nut cakes may be produced. Kits may be packaged with ingredients and sold for home cooking.

A method of preparing ready to eat cold nut cakes is also disclosed herein comprising the steps of: removing the nuts from plants; removing external layers of the nuts thereby exposing a fleshy part of the nuts; grinding the fleshy part of the nuts into very fine particles (of flour); stirring, mixing, and cooking via boiling the nuts, with ingredients, seasonings and flavorings, and binding agents to form nut cakes; storing the nut cakes in a refrigerator to congeal and solidify; and packaging to preserve their freshness once solidified.

The present invention holds significant improvements and serves as a ready to eat cold nut cakes with ingredients system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ready to eat cold nut cakes, constructed and operative according to the teachings of the present invention.

FIG. 1 shows a perspective view illustrating ready to eat cold nut cakes according to an embodiment of the present invention.

FIG. 2 is a perspective view illustrating the ready to eat cold nut cakes according to an embodiment of the present invention of FIG. 1.

FIG. 3 is a flowchart illustrating a method of preparing ready to eat cold nut cakes according to an embodiment of the present invention of FIGS. 1-2.

The various embodiments of the present invention will hereinafter be described in conjunction with the appended drawings, wherein like designations denote like elements.

### DETAILED DESCRIPTION

As discussed above, embodiments of the present invention relate to a comestible and more particularly to ready to eat cold nut cakes as used to improve the health of consumers. Generally speaking, the purpose as previously mentioned is to create cold and ready to eat nut cakes, with a variety of ingredient in combinations suitable for healthy consumption.

Nuts as referred to herein comprise the dried fruits and seeds of plants, which are hard-walled edible kernels. The nuts can include almond, cashew, chestnut, coconut, pecan, hazelnut, macadamia, walnut, acorn, pistachio, peanut, pine nut, Brazil nut, pumpkin seed, sesame seed, sunflower seed, lotus seed, and the like. Nuts as used in the present invention are preferably high in nutritional value, including protein, carbohydrates, fiber, vitamins, minerals, antioxidants, unsaturated fats, and essential fatty acids. The present invention serves to promote health in persons eating the comestible; those with nut allergies should not consume such products.

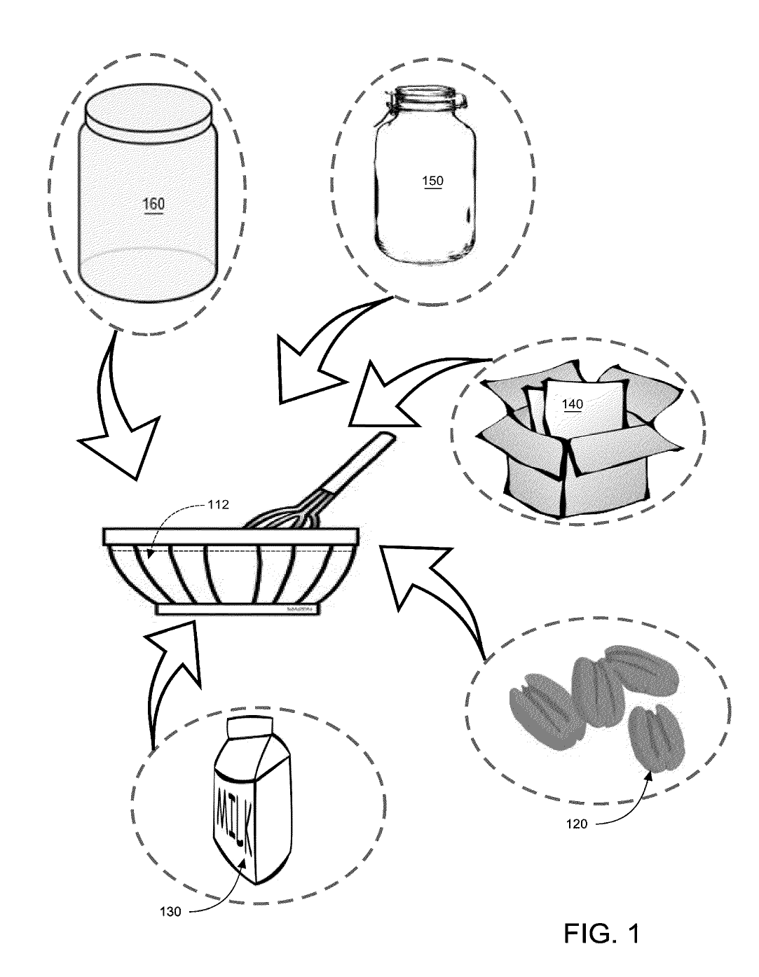

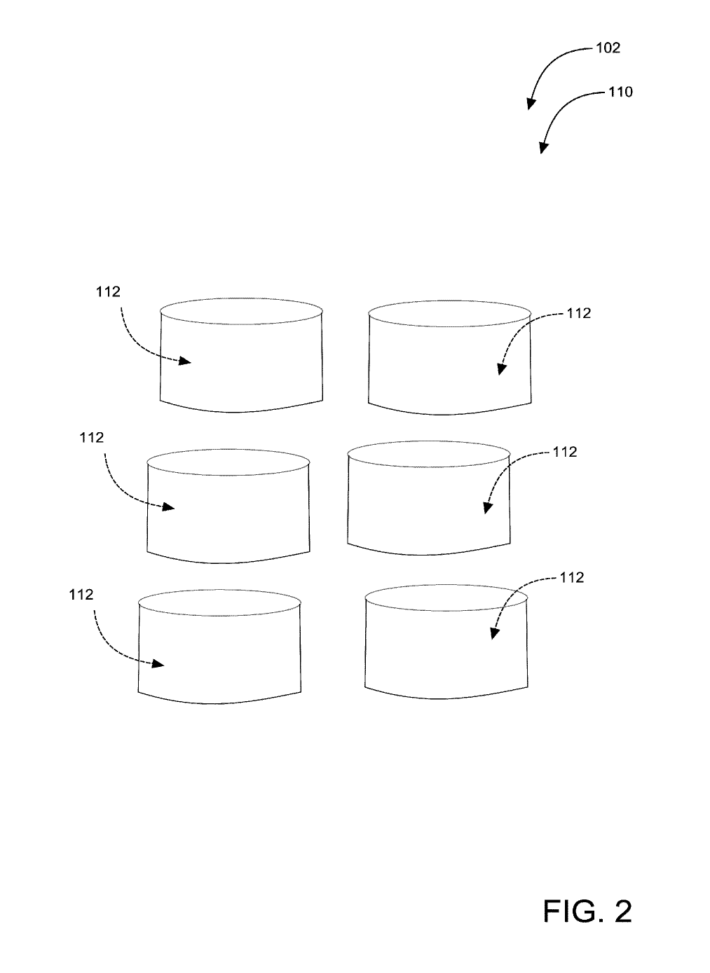

Referring to the drawings by numerals of reference there is shown in FIGS. 1-2, perspective views illustrating ready to eat cold nut cakes 110 according to embodiments of the present invention.

Ready to eat cold nut cake product 102 comprises ingredients combined in proportions substantially including nuts 120; milk 130; gelling agent 140; additives 150; and flavorings 160. Nuts 120 are ground into very fine particles to form fine flour for smooth and even texture in the final product.

Nuts 120 are preferably selected from the group consisting of almond, cashew, chestnut, coconut, pecan, hazelnut, macadamia, walnut, acorn, pistachio, peanut, pine nut, Brazil nut, pumpkin seed, sesame seed, sunflower seed, and lotus seed. The flour (of nuts 120), milk 130, gelling agent 140, additives 150 and flavorings 160 are stirred, mixed as an admixture and cooked to form nut cakes 112 as the ready to eat cold nut cake product 102. Gelling agent 140 causes the admixture to congeal after being cooked when the admixture is cooled using refrigeration. The flavorings cause nut cakes 112 to be flavored appropriately as desired for consumption. Nut cakes 112, as such, are high in nutrition and suitable for readily consuming

Milk 130 used herein is preferably selected from the group consisting of whole milk, lowfat milk, nonfat milk, soy milk, coconut milk, almond milk, and vanilla milk. Gelling agent 140 is an edible binder and may comprise gelatin high in protein in certain embodiments and in other embodiments may comprise a starch component. The embodiment using starch may be reheated in a microwave oven and/or in a conventional oven which may be desirable for consumers to avoid food waste. The binding agents can include starch components such as corn starch, potato starch, tapioca, sago; and gelatin, or egg white; with gelatin being high in the nutrition of protein.

Ready to eat cold nut cake product 102 comprises flavorings 160; flavorings 160 are preferably selected from the group consisting of sugar, syrup, honey, maple syrup, cinnamon, salt, pepper, garlic, ginger, onion, chili, curry, vinegar, lemon, lime, basil, thyme, parsley, peppermint, rosemary, soup stock and broth. Upon reading this specification, it should be appreciated that, under appropriate circumstances, considering such issues as user preferences, design preference, structural requirements, marketing preferences, cost, available materials, technological advances, etc., other flavoring, seasoning, ingredients, additives, toppings, salt source(s), and combinations thereof may be used. The embodiments and combinations disclosed herein are exemplary and are not intended to be limiting the scope of the present invention in any way, rather they have been provided such that the reader may have working examples by which to reproduce ready to eat cold nut cake product 102.

Ready to eat cold nut cake product 102 may further comprise at least one topping; the topping(s) is preferably selected from the group consisting of chocolate, chocolate sauce, caramel, butterscotch, apple sauce, and fruit. Ready to eat cold nut cake product 102 may further comprise a salt source; the salt source is preferably selected from the group consisting of vegetables, seafood, meat, bean, cereal, cheese, and egg; the salt source cut into small pieces and intermixed within the admixture when preparing.

The vegetables (if used as a salt source for flavoring) are preferably selected from the group consisting of onion, garlic, mushroom, spinach, carrot, pea, corn, beet, radish, turnip, pepper, tomato, asparagus, cucumber, zucchini, eggplant, and squash; however depending on consumer preference other forms of vegetables may be used.

In certain embodiments ready to eat cold nut cake product 102 may comprise at least one seafood to increase quality nutritional intake. In these embodiments the seafood is preferably selected from the group consisting of squid, cuttle fish, shrimp, crab, crayfish, octopus, clam, oyster, scallop, lobster, abalone, conch, jellyfish, shrimp roe, fish roe, and fish. Alternately, ready to eat cold nut cake product 102 may further comprise meat; meat, when used, is preferably selected from the group consisting of chicken, pork, beef, lamb, bacon, and sausage. Other meats may be used if desired.

Ready to eat cold nut cake product 102 may further comprise fruit juice to make fruity flavored versions of nut cakes 112; the fruit juices are preferably selected from the group consisting of apple juice, orange juice, lemon juice, lime juice, grapefruit juice, grape juice, pear juice, plum juice, strawberry juice, cranberry juice, blueberry juice, pomegranate juice, mango juice, guava juice, pineapple juice, coconut juice, and pomelo juice. The additives 150 are preferably selected from the group consisting of coffee, tea, chocolate, chocolate chips, raisins, caramel, butterscotch, marshmallow, peanut butter, cheese, cream, yogurt, egg, bean, and cereal, as per consumer preference. As such the present invention may be flavored to suit consumer taste and dietary needs. Many combinations are listed subsequently as exemplary embodiments to create cold and ready to eat nut cakes, with a variety of ingredient combinations suitable for healthy consumption.

### Examples

An example of the present invention is a nut cake 112 made with almond, milk and gelatin. Another example may comprise sweet nut cake 112 with fruit juice being used is made with coconut, milk, grapefruit juice, sugar and gelatin. Yet another example of sweet nut cake 112 is made with pistachio, orange juice and gelatin. An example of a salty nut cake 112 may be made with macadamia, shrimp, onion, salt, vinegar, corn starch and gelatin. Another example of the salty and spicy nut cake 112 is made with pine nut, cuttle fish, salt, garlic, chili, corn starch and gelatin. Many other combinations are possible.

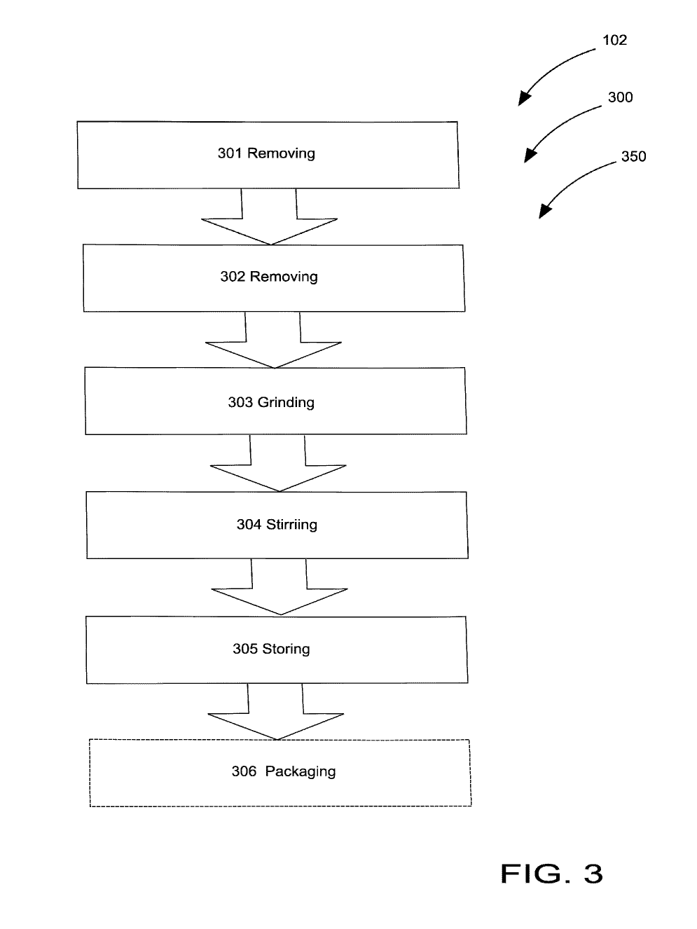

Referring now to FIG. 3, a flowchart 350 illustrating a method of preparing 300 ready to eat cold nut cakes 110 according to an embodiment of the present invention of FIGS. 1-2.

A method of preparing 300 ready to eat cold nut cakes 102 comprises the steps of: step one 301 removing nuts 120 from plants; step two 302 removing external layers of nuts 120 thereby exposing a fleshy part of nuts 120; step three 303 grinding the fleshy part of nuts 120 into very fine particles; step four 304 stiffing, mixing, and cooking via boiling nuts 120, with ingredients, seasonings and flavorings 160, and binding agents (gelling agent 140) to form nut cakes 112; step six 305 storing nut cakes 112 in a refrigerator to congeal and solidify; and optionally step seven 306 packaging to preserve freshness once solidified. Nut cakes 112 can be packaged into air tight containers to preserve freshness as ready to eat cold nut cake product 102. The containers can be made of paper, plastic, glass, metal. The serving size can be a single serving, or a six pack of servings. Each serving can be contained in a cubical shaped container, with each side of the container about 3 to 4 inches in length. Nut cakes 112 are stored in the refrigerator and ready to eat. Cold and ready to eat nut cakes 112 (ready to eat cold nut cakes 110) can be served as breakfast, lunch, dinner, desert, or as a snack food.

It should be noted that step 306 is an optional step and may not be implemented in all cases. Optional steps of method 300 are illustrated using dotted lines in FIG. 3 so as to distinguish them from the other steps of method 300.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ready to eat cold nut cake product comprising ingredients combined in proportions substantially including:
nuts;
milk;
a gelling agent;
additives; and
flavorings;
wherein said nuts are ground into very fine particles to form fine flour;
wherein said flour, said milk, said gelling agent, said additives and said flavorings are stirred, mixed as an admixture and cooked to form nut cakes as said ready to eat cold nut cake product;
wherein said gelling agent causes said admixture to congeal after being cooked when said admixture is cooled using refrigeration;
wherein said flavorings cause said nut cakes to be flavored for consumption; and
wherein said nut cakes are high in nutrition and suitable for readily consuming.

2. The ready to eat cold nut cake product of claim 1 wherein said gelling agent is an edible binder and comprises gelatin high in protein.

3. The ready to eat cold nut cake product of claim 1 wherein said gelling agent is an edible binder and comprises a starch component.

4. The ready to eat cold nut cake product of claim 3 wherein said starch component, when used, allows said nut cakes to be reheated in a microwave oven and in a conventional oven.

5. The ready to eat cold nut cake product of claim 1 wherein said flavorings are selected from the group consisting of sugar, syrup, honey, maple syrup, cinnamon, salt, pepper, garlic, ginger, onion, chili, curry, vinegar, lemon, lime, basil, thyme, parsley, peppermint, rosemary, soup stock and broth.

6. The ready to eat cold nut cake product of claim 1 further comprising a topping.

7. The ready to eat cold nut cake product of claim 6 wherein said topping is selected from the group consisting of chocolate, chocolate sauce, caramel, butterscotch, apple sauce, and fruit.

8. The ready to eat cold nut cake product of claim 1 further comprising a salt source.

9. The ready to eat cold nut cake product of claim 8 wherein said salt source is selected from the group consisting of vegetables, seafood, meat, bean, cereal, cheese, and egg, said salt source cut into small pieces.

10. The ready to eat cold nut cake product of claim 9 wherein said vegetables are selected from the group consisting of onion, garlic, mushroom, spinach, carrot, pea, corn, beet, radish, turnip, pepper, tomato, asparagus, cucumber, zucchini, eggplant, and squash.

11. The ready to eat cold nut cake product of claim 1 of claim 1 further comprising a seafood.

12. The ready to eat cold nut cake product of claim 11 wherein said seafood is selected from the group consisting of squid, cuttle fish, shrimp, crab, crayfish, octopus, clam, oyster, scallop, lobster, abalone, conch, jellyfish, shrimp roe, fish roe, and fish.

13. The ready to eat cold nut cake product of claim 1 wherein said milk is selected from the group consisting of whole milk, lowfat milk, nonfat milk, soy milk, coconut milk, almond milk, and vanilla milk.

14. The ready to eat cold nut cake product of claim 1 wherein said nuts are selected from the group consisting of almond, cashew, chestnut, coconut, pecan, hazelnut, macadamia, walnut, acorn, pistachio, peanut, pine nut, Brazil nut, pumpkin seed, sesame seed, sunflower seed, and lotus seed.

15. The ready to eat cold nut cake product of claim 1 further comprising fruit juice to make fruity flavored said nut cakes.

16. The ready to eat cold nut cake product of claim 15 wherein said fruit juices are selected from the group consisting of apple juice, orange juice, lemon juice, lime juice, grapefruit juice, grape juice, pear juice, plum juice, strawberry juice, cranberry juice, blueberry juice, pomegranate juice, mango juice, guava juice, pineapple juice, coconut juice, and pomelo juice.

17. The ready to eat cold nut cake product of claim 1 wherein said additives are selected from the group consisting of coffee, tea, chocolate, chocolate chips, raisins, caramel, butterscotch, marshmallow, peanut butter, cheese, cream, yogurt, egg, bean, and cereal.

18. The ready to eat cold nut cake product of claim 1 further comprising meat.

19. The ready to eat cold nut cake product of claim 18 wherein said meat is selected from the group consisting of chicken, pork, beef, lamb, bacon, and sausage.

20. A method of preparing ready to eat cold nut cakes comprising the steps of:
removing nuts from plants;
removing external layers of the nuts thereby exposing a fleshy part of the nuts;
grinding the fleshy part of the nuts into very fine particles;
stirring, mixing, and cooking via boiling the nuts, with ingredients, seasonings and flavorings, and binding agents to form nut cakes;
storing the nut cakes in a refrigerator to congeal and solidify; and
packaging to preserve freshness once solidified.
